(19) United States
(12) Patent Application Publication
(10) Pub. No.: US 2024/0287114 A1
(43) Pub. Date: Aug. 29, 2024

(54) PLATINUM COMPLEX, ITS PREPARATION AND THERAPEUTIC USE

(71) Applicant: CITY UNIVERSITY OF HONG KONG, Kowloon (HK)

(72) Inventors: Guangyu ZHU, Kowloon (HK); Zoufeng XU, Kowloon (HK); Qiyuan ZHOU, Kowloon (HK)

(21) Appl. No.: 18/435,998

(22) Filed: Feb. 7, 2024

Related U.S. Application Data
(62) Division of application No. 17/327,517, filed on May 21, 2021, now abandoned.
(60) Provisional application No. 63/028,646, filed on May 22, 2020.

(51) Int. Cl. C07F 15/00

(52) U.S. Cl. CPC C07F 15/0086

(57) ABSTRACT

A platinum complex comprises a chemical structure of Structure (II):

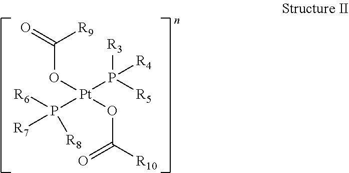

where R₃, R₄, R₅, R₆, R₇ and RE are independently selected From a hydrogen atom, a substituted or unsubstituted linear or branched chain C1 to C5 alkyl group, a cycloalkyl group, a substituted or unsubstituted aryl group, and a heteroaryl group, R₉ and R₁₀ are independently selected from the group consisting of a hydrogen atorn, a substituted or unsubstituted linear or branched chain C1 to C5 alkyl group, a substituted or unsubstituted aryl group, and a carboxyl group; and n is an electrical charge of the complex and is 0, a positive integer or a negative integer.

### CROSS-REFERENCE TO RELATED APPLICATIONS

This application claims priority to and is a divisional of U.S. patent application Ser. No. 17/327,517 filed on Nov. 8, 2023 entitled “PLATINUM COMPLEX, ITS PREPARATION AND THERAPEUTIC USE”, which claims priority to U.S. Patent Provisional Application Ser. No. 63/028,646 filed on May 22, 2020, entitled “PLATINUM COMPLEX, ITS PREPARATION AND THERAPEUTIC USE”; each of which is incorporated herein by reference in their entirety for all purposes.

### BACKGROUND

This invention relates to phosphine coordinated platinum complexes, particularly but not exclusively to phosphine coordinated platinum complexes which may be used for treatment of cancer, more particularly for inhibition of tumor cell growth. The invention also relates to methods of making the complexes, dosage forms including the complexes and methods of treatment using the complexes and dosage forms.

Platinum has been used as a cancer therapeutic for many years. Cisplatin defined the platinum based cancer therapeutics field when it was first discovered in 1845 and then subsequently licensed for medical use in 1978. Platinum-based anticancer drugs including cisplatin have been extensively used in the clinic to treat different types of cancer patients. Although more than 50% of cancer patients have been treated with platinum-based anticancer drugs, the drugs are facing lots of issues including toxic side effects and drug resistance.

Therefore, novel anticancer agents that are able to conquer drug resistance issues are highly desired. In certain embodiments, the phosphine-coordinated platinum complexes of the present invention aim to provide activity against cancer cell growth. In addition, certain embodiments of the present invention aim to provide efficacy in killing human cancer cells. The present invention aims to provide complexes of certain embodiments that are more efficacious as a cancer therapy than cisplatin. This is particularly true for cancer cell lines that are cisplatin-resistant.

### BRIEF SUMMARY OF THE DISCLOSURE

In accordance with a first aspect of the present invention there is provided a platinum complex having a chemical structure of Structure I:

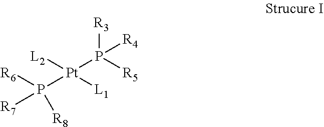

wherein
L₁ and L₂ are independently selected from electron donor ligands, including but not limited to halogen ligands, hydroxo ligands, carboxylato ligands, and alkoxido ligands;
R₃, R₄, R₅, R₆, R₇ and R₈ are each independently selected from the group consisting of a hydrogen atom, hydrocarbon group, or heterocyclic group;
wherein the hydrocarbon group is selected from the group consisting of: alkyl, alkenyl, cycloalkyl, phenyl, and naphthyl which may optionally be substituted by at least one functional group selected from the group consisting of: hydroxy, halogen, alkoxy, alkoxycarbonyl, carboxy, amido, amino, nitro, cyano, carbamate, urea, sulfonyl, sulfenyl, phosphenyl, phosphinyl, sulfide, thioether, thioester, sugar moiety, cyclodextrin, and porphyrin ring; and the heterocyclic group is selected from the group consisting of: pyridyl, piperidyl, azino, azolyl, imidazolyl, triazinyl, furyl and carbozolyl; or two adjacent R₃, R₄, R₅, R₆, R₇ and R₈ groups form a heterocycle or a carbocycle with or without an intermediary hetero atom or intermediary hetero atoms.

In embodiments the platinum complex has a structure of Structure II:

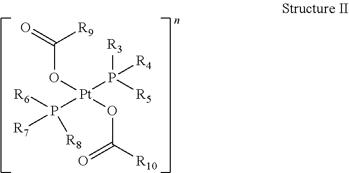

wherein
R₃, R₄, R₅, R₆, R₇ and R₈ are independently selected from a hydrogen atom, a substituted or unsubstituted linear or branched chain C1 to C5 alkyl group, a cycloalkyl group, a substituted or unsubstituted aryl group, or a heteroaryl group, optionally R₃ is identical to R₆, R₄ is identical to R₇, and R₅ is identical to R₈;
R₉ and R₁₀ are independently selected from a hydrogen atom, a substituted or unsubstituted linear or branched chain C1 to C5 alkyl group, a substituted or unsubstituted aryl group, or a carboxyl group; and
n is an electrical charge of the complex and is selected from zero, any positive integer or negative integer (optionally n is 0, or 2+).

As stated above, n is an electrical charge of the complex. As the skilled person would appreciate, the complex may consequently have a counter ion to provide a balancing electrical charge. In embodiments, the complex optionally further comprises a counter ion selected from: anions, including but not limited to nitrogen (N)-containing anions, oxygen (O)-containing anions, phosphorous (P)-containing anions, sulfur (S)-containing anions, and halogen containing anions. Preferably, the counter ion is a halide counter ion, such as chloride.

When substituted a group may be substituted with a halo group, —NH₂, an amine substituted with one or two C1-C5 alkyl, a linear or branched chain C1 to C5 alkyl group, a C1 to C5 alkoxy group, a C1 to C5 acyl group or a C1 to C5 carboxyl group.

In embodiments R₃, R₄, R₆, and R₇ are independently selected from: a substituted or unsubstituted aryl group, or a heteroaryl group. In embodiments R₃, R₄, R₆, and R₇ are independently selected from: an unsubstituted aryl group; an aryl group substituted with a halo group, a linear or branched chain C1 to C5 alkyl group, or a C1 to C5 alkoxy group; and a heteroaryl group.

In embodiments R₃, R₄, R₆, and R₇ are independently selected from: phenyl, tolyl, chlorophenyl, methoxyphenyl, and fluorophenyl.

In embodiments R₃, R₄, R₆ and R₇ are selected from any one of the following groups: a phenyl group,

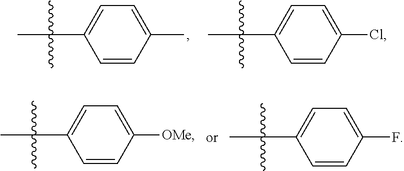

Optionally, R₃, R₄, R₆ and R₇ are identical.

In embodiments R₅ and R₈ are independently selected from: an unsubstituted linear or branched chain C1 to C5 alkyl group, a cycloalkyl group (optionally a C4 to C8 cycloalkyl group), a substituted or unsubstituted aryl group, or a heteroaryl group.

In embodiments R₅ and R₈ are independently selected from: a C4 to C8 cycloalkyl group, an unsubstituted aryl group, a heteroaryl group, and an aryl group substituted with a halo group, —NH₂, an amine substituted with one or two C1 to C5 alkyl groups, a linear or branched chain C1 to C5 alkyl group, or a C1 to C5 alkoxy group.

In embodiments R₅ and R₈ are independently selected from: ethyl, cyclohexyl, pyridyl, tolyl, chlorophenyl, fluorophenyl, N,N-dimethylaminophenyl, methoxy phenyl.

In embodiments R₅ and R₈ are selected from any one of the following groups:

an ethyl group,

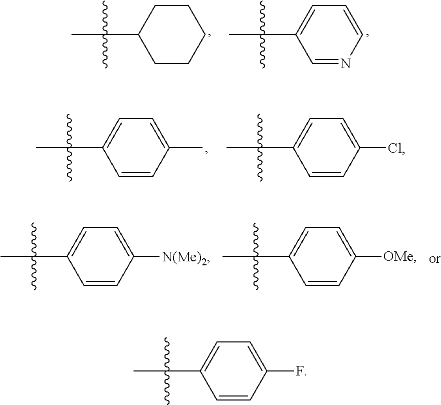

Optionally, R₅ and R₈ are identical

In embodiments R₉ and R₁₀ are independently selected from: a linear chain C1 to C5 alkyl group; a C1 to C5 carboxyl group; an unsubstituted aryl group (preferably a C6 to C10 aryl group); and an aryl group (preferably a C6 to C10 aryl group) substituted with a branched or linear chain C1 to C5 alkyl group, a C1 to C5 acyl group; a C1 to C5 carboxyl group (optionally—C(O)₂H).

In embodiments R₉ and R₁₀ are independently selected from: methyl, phenyl, carboxypropyl, and carboxyphenyl.

In embodiments R₉ and R₁₀ are independently selected from any one of the following groups: a methyl group,

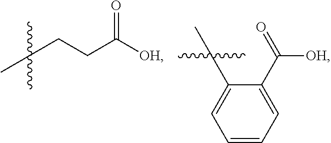 [SMILES: *CCC(=O)O ; *c1ccccc1C(=O)O]

or a phenyl group.

In embodiments the platinum complex is a platinum complex, wherein: R₁, and R₂ are independently selected from any one of the following groups: a methyl group,

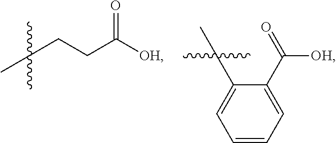 [SMILES: *CCC(=O)O ; *c1ccccc1C(=O)O]

or a phenyl group;
R₃, R₄, R₆ and R₇ are identical, and they are selected from any one of the following groups:
   a phenyl group,

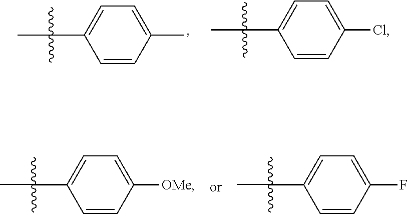

R₅ and R₈ are identical and are selected from any one of the following groups:
an ethyl group,

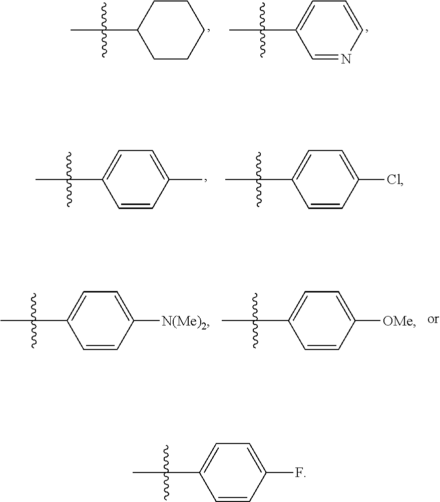

In embodiments the platinum complex is a complex having the structure of Structure II wherein:
R₃, R₄, R₅, R₆, R₇ and R₈ are phenyl and R₉ and R₁₀ are methyl;
R₃, R₄, R₅, R₆, R₇ and R₈ are phenyl and R₉ and R₁₀ are;

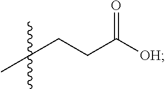 [SMILES: *CCC(=O)O]

R₃, R₄, R₅, R₆, R₇ and R₈ are phenyl and R₉ and R₁₀ are;

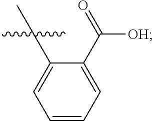 [SMILES: *c1ccccc1C(=O)O]

R₃, R₄, R₅, R₆, R₇ and R₈ are phenyl; R₉ is methyl, and R₁₀ are phenyl; and

R₃, R₄, R₅, R₆, R₇ and R₈ are phenyl; R₉ is phenyl, and R₁₀ is

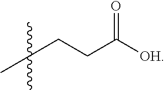 [SMILES: *CCC(=O)O]

In embodiments the platinum complex is a complex having the structure of Structure III:

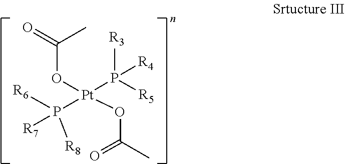

In embodiments the platinum complex is a complex having the structure of Structure III wherein:

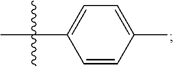 [SMILES: *c1ccc(C)cc1]

R₃, R₄, R₆ and R₇ are phenyl and R₅ and R₈ are;

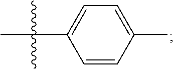 [SMILES: *c1ccc(C)cc1]

R₃, R₄, R₅, R₆, R₇ and R₈ are;

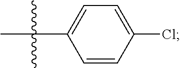 [SMILES: *c1ccc(Cl)cc1]

R₃, R₄, R₅, R₆, R₇ and R₈ are;

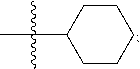 [SMILES: *C1CCCCC1]

R₃, R₄, R₆ and R₇ are phenyl and R₅ and R₈ are R₃, R₄, R₆ and R₇ are phenyl and R₅ and R₈ are

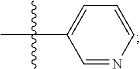 [SMILES: *c1cccnc1]

In embodiments the platinum complex is a complex having the structure of Structure IV:

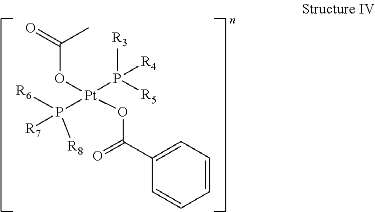

In embodiments where the metal complex has any structure disclosed herein, PR₆R₇R₈ and PR₃R₄R₅ are represented by the following phosphine ligands:

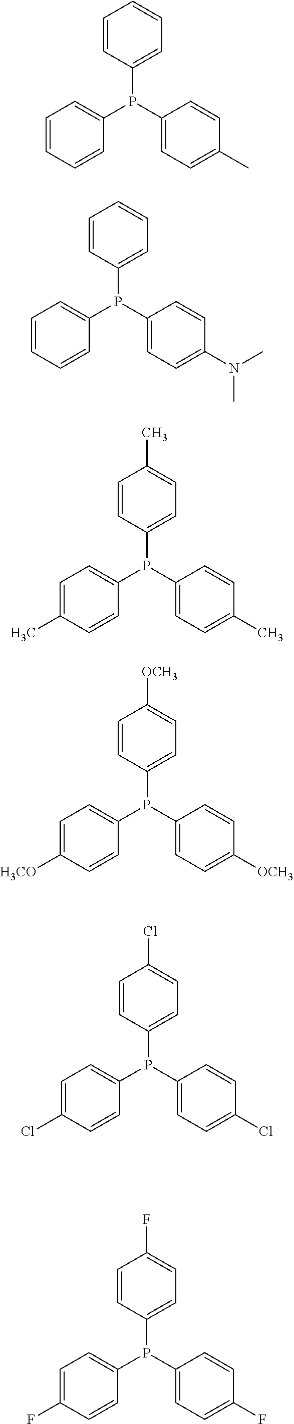

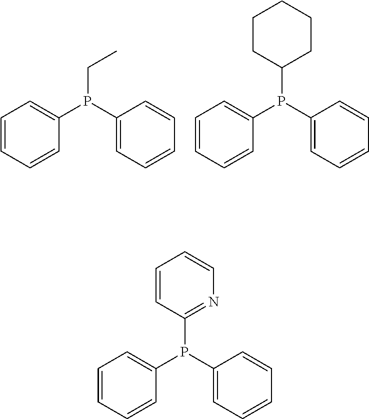

According to a further aspect of the present invention there is provided a process for preparing a compound of the present invention by the reaction of [PtXX′YY′L₁L₂] and the corresponding phosphine ligands (PR₃R₄R₅ or PR₆R₇R₈), wherein R₃ is identical to R₆, R₄ is identical to R₇, and R₅ is identical to R₈:

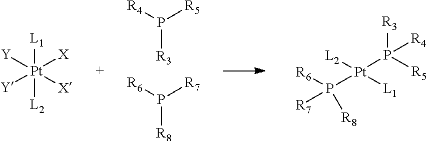

wherein:
X, X, Y, and Y′ are selected from electron donor ligands, including but not limited to nitrogen (N)-containing ligands, oxygen (O)-containing ligands, phosphorous (P) containing ligands, sulfur (S)-containing ligands, and halogen containing ligands;
L₁ and L₂ are independently selected from electron donor ligands, including but not limited to halogen ligands, hydroxo ligands, carboxylato ligands and alkoxido ligands;
R₃, R₄, R₅, R₆, R₇ and R₈ are each independently selected from the group consisting of a hydrogen atom, hydrocarbon group, or heterocyclic group; hydrocarbon group including but not limited to alkyl, alkenyl, cycloalkyl, phenyl, and naphthyl which may optionally be substituted by at least one functional group selected from the group consisting of
hydroxy, halogen, alkoxy, alkoxycarbonyl, carboxy, amido, amino, nitro, cyano, carbamate, urea, sulfonyl, sulfenyl, phosphenyl, phosphinyl, sulfide, thioether, thioester, sugar moiety, cyclodextrin, and porphyrin ring; heterocyclic group is selected from the group consisting of pyridyl, piperidyl, azino, azolyl, imidazolyl, triazinyl, furyl and carbozolyl; or adjacent R₁, R₂, and R₃ may form a heterocycle or a carbocycle with or without an intermediary hetero atom or intermediary hetero atoms.

According to a further aspect of the present invention there is provided a platinum complex of Structure V:

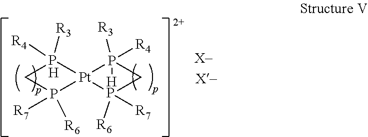

wherein
p is the number of methylene groups, which may be 1, 2, 3, or 4;
X- and X′-are selected from anions, including but not limited to nitrogen (N)-containing anions, oxygen (O)-containing anions, phosphorous (P)-containing anions, sulfur (S)-containing anions, and halogen containing anions;
R₃, R₄, R₆ and R₇ are each independently selected from the group consisting of a hydrogen atom, hydrocarbon group, or heterocyclic group; hydrocarbon group including but not limited to alkyl, alkenyl, cycloalkyl, phenyl, and naphthyl which may optionally be substituted by at least one functional group selected from the group consisting of hydroxy, halogen, alkoxy, alkoxycarbonyl, carboxy, amido, amino, nitro, cyano, carbamate, urea, sulfonyl, sulfenyl, phosphenyl, phosphinyl, sulfide, thioether, thioester, sugar moiety, cyclodextrin, and porphyrin ring; heterocyclic group is selected from the group consisting of pyridyl, piperidyl, azino, azolyl, imidazolyl, triazinyl, furyl and carbozolyl; or adjacent R₃, R₄, R₆ and R₇ may form a heterocycle or a carbocycle with or without an intermediary hetero atom or intermediary hetero atoms.

In embodiments R₃, R₄, R₆ and R₇ have any definition set out herein.

Preferably, R₃, R₄, R₆ and R₇ are phenyl. Preferably, X- and X′-are halogen containing anions such as chloride.

In embodiments the platinum complex may have a structure selected from Structure VIa and VIb:

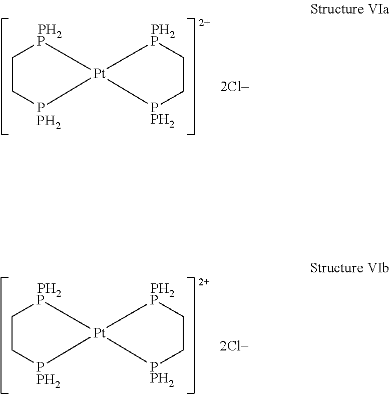

According to an aspect of the present invention there is provide a process for preparing a compound of the present invention by a reaction of [PtXX‘YY’L₁L₂] and the corresponding chelating phosphine ligands:

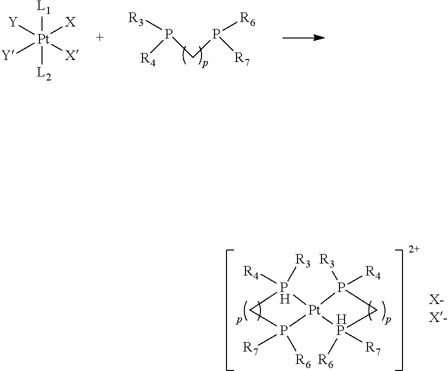

wherein
n is the number of methylene groups, which may be 1, 2, 3, or 4;
X- and X′-are selected from anions, including but not limited to nitrogen (N)-containing anions, oxygen (O)-containing anions, phosphorous (P)-containing anions, sulfur (S)-containing anions, and halogen containing anions;
Y, and Y′ are selected from electron donor ligands, including but not limited to nitrogen (N)-containing ligands, oxygen (O)-containing ligands, phosphorous (P)-containing ligands, sulfur (S)-containing ligands, and halogen containing ligands;
L₁ and L₂ are independently selected from electron donor ligands, including but not limited to halogen ligands, hydroxo ligands, carboxylato ligands and alkoxido ligands;
R₃, R₄, R₆ and R₇ each independently selected from the group consisting of a hydrogen atom, hydrocarbon group, or heterocyclic group; hydrocarbon group including but not limited to alkyl, alkenyl, cycloalkyl, phenyl, and naphthyl which may optionally be substituted by at least one functional group selected from the group consisting of hydroxy, halogen, alkoxy, alkoxycarbonyl, carboxy, amide, amino, nitre, cyano, carbamate, urea, sulfonyl, sulfenyl, phosphenyl, phosphinyl, sulfide, thioether, thioester, sugar moiety, cyclodextrin, and porphyrin ring; heterocyclic group is selected from the group consisting of pyridyl, piperidyl, azino, azolyl, imidazolyl, triazinyl, furyl and carbozolyl; or adjacent R₃, R₄, R₆ and R₇ may form a heterocycle or a carbocycle with or without an intermediary hetero atom or intermediary hetero atoms.

In a further aspect of the present invention, there is provided a method of treating a subject suffering from a cancer comprising administering an effective amount of the platinum complex of the present invention to a subject.

In a further aspect, there is provided a metal complex of the present invention for use in a method of treating cancer.

In another aspect the present invention there is provided a pharmaceutical dosage form comprising a complex in accordance with this invention and one of more excipients.

In embodiments of the method and the metal complex for use, the cancer is selected from an ovarian cancer, a lung cancer, or a breast cancer.

In particular the cancer may be a cisplatin resistant cancer cell line. For example, a cisplatin resistant ovarian cancer, a cisplatin resistant lung cancer, or a cisplatin resistant breast cancer.

In embodiments of the method and the metal complex for use, the cancer is selected from the following cancer cell lines: A2780, A2780CisR, A549 and A549CisR and MCF-7.

### DETAILED DESCRIPTION

A platinum complex comprising a structure of Formula (I):

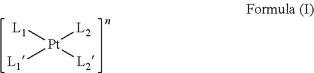

L₁, L₁′, L₂, and L₂′ are independently selected from a nitrogen-containing ligand, an oxygen containing ligand, a phosphorous-containing ligand, a sulfur-containing ligand or a halogen containing ligand, optionally L₁, and L₁′, are linked to form a first bidentate ligand, and L₂, and L₂′ are linked to form a second bidentate ligand; and
n is selected from zero, any positive integer or negative integer.

In embodiments L₁, L₁′, L₂, and L₂′ are independently selected from hydroxido, halido, carboxylato, alkoxido, or substituted or unsubstituted phosphine ligand.

In embodiments L₁, L₁′, L₂, and L₂′ are identical.

In embodiments the platinum complex has a structure of Formula (IIa):

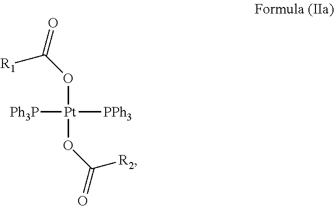

wherein R₁ and R₂ are independently selected from any one of the following groups: a methyl group,

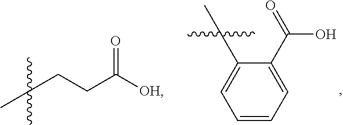 [SMILES: *CCC(=O)O ; *c1ccccc1C(=O)O]

or a phenyl group.

In embodiments the platinum complex has a structure of Formula (IIb):

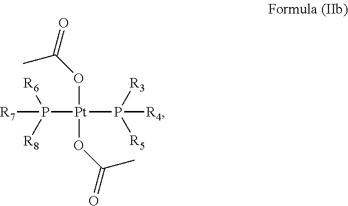

and
wherein
R₃, R₄, R₆ and R₇ are identical, and they are selected from any one of the following groups: a phenyl group,

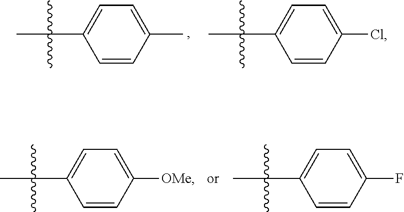

R₅, and R₈ are identical and are selected from any one of the following groups:
an ethyl group,

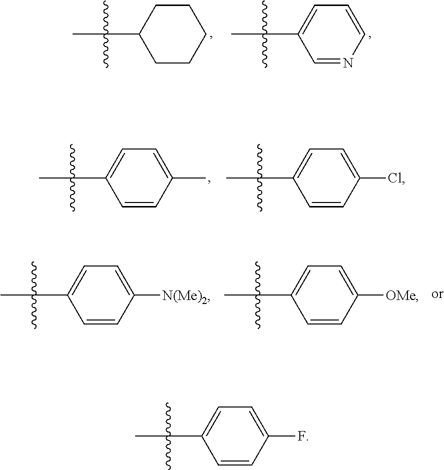

In embodiments the platinum complex has a structure of Formula (III)

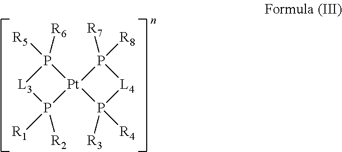

R₁, R₂, R₃, R₄, R₅, R₆, R₇ and R₈ are independently selected from a hydrogen atom, a substituted or unsubstituted linear or branched chain C1 to C5 alkyl group, a substituted or unsubstituted aryl group, or a heteroaryl group;
L₃ and L₄, are independently a linker group of —(CH₂)ₘ₋ with m being 1, 2, 3 or 4, preferably L₃ and L₄, are identical; and
n is selected from zero, any positive integer or negative integer.

In an aspect of the present invention, there is provided a method of treating a subject suffering from a cancer comprising administering an effective amount of the platinum complex of the present invention to a subject.

The present invention also relates to a platinum complex for use in the method of treatment.

In embodiments, the cancer is selected from an ovarian cancer, a lung cancer, or a breast cancer.

In embodiments, the platinum complex for use in the method of treatment is a platinum complex comprising a chemical structure of Structure I:

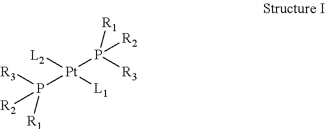

wherein
L₁ and L₂ are independently selected from electron donor ligands, including but not limited to halogen ligands, hydroxo ligands, carboxylato ligands, and alkoxido ligands;
R₁, R₂ and R₃ are each independently selected from the group consisting of a hydrogen atom, hydrocarbon group, or heterocyclic group;
wherein the hydrocarbon group is selected from: alkyl, alkenyl, cycloalkyl, phenyl, and naphthyl which may optionally be substituted by at least one functional group selected from the group consisting of: hydroxy, halogen, alkoxy, alkoxycarbonyl, carboxy, amido, amino, nitro, cyano, carbamate, urea, sulfonyl, sulfenyl, phosphenyl, phosphinyl, sulfide, thioether, thioester, sugar moiety, cyclodextrin, and porphyrin ring; and the heterocyclic group is selected from the group consisting of: pyridyl, piperidyl, azino, azolyl, imidazolyl, triazinyl, furyl and carbozolyl;
or two adjacent R₁, R₂ and R₃ groups form a heterocycle or a carbocycle with or without an intermediary hetero atom or intermediary hetero atoms.

In embodiments, the platinum complex for use in the method of treatment is the platinum complex having a structure of Structure (II):

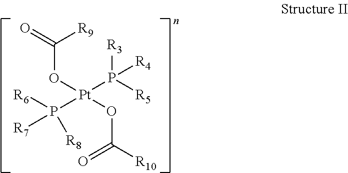

wherein
R₃, R₄, R₅, R₆, R₇ and R₈ are independently selected from a hydrogen atom, a substituted or unsubstituted linear or branched chain C1 to C5 alkyl group, a cycloalkyl group, a substituted or unsubstituted aryl group, or a heteroaryl group, optionally R₃ is identical to R₆, R₄ is identical to R₇, and R₅ is identical to R₈;
R₉ and R₁₀ are independently selected from a hydrogen atom, a substituted or unsubstituted linear or branched chain C1 to C5 alkyl group, a substituted or unsubstituted aryl group, or a carboxyl group; and
n is selected from zero, any positive integer or negative integer (optionally n is 0, or 2+).

In embodiments, the platinum complex for use in the method of treatment is a platinum complexes of Structure V:

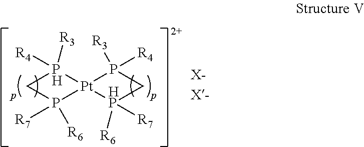

wherein
p is the number of methylene groups, which may be 1, 2, 3, or 4;
X- and X′-are selected from anions, including but not limited to nitrogen (N)-containing anions, oxygen (O)-containing anions, phosphorous (P)-containing anions, sulfur (S)-containing anions, and halogen containing anions;
R₃, R₄, R₆ and R₇ are each independently selected from the group consisting of a hydrogen atom, hydrocarbon group, or heterocyclic group; hydrocarbon group including but not limited to alkyl, alkenyl, cycloalkyl, phenyl, and naphthyl which may optionally be substituted by at least one functional group selected from the group consisting of hydroxy, halogen, alkoxy, alkoxycarbonyl, carboxy, amido, amino, nitro, cyano, carbamate, urea, sulfonyl, sulfenyl, phosphenyl, phosphinyl, sulfide, thioether, thioester, sugar moiety, cyclodextrin, and porphyrin ring; heterocyclic group is selected from the group consisting of pyridyl, piperidyl, azino, azolyl, imidazolyl, triazinyl, furyl and carbozolyl; or adjacent R₃, R₄, R₆ and R₇ may form a heterocycle or a carbocycle with or without an intermediary hetero atom or intermediary hetero atoms.

In embodiments, the platinum complex for use in the method of treatment is a complex having a structure of Structure VIa or VIb:

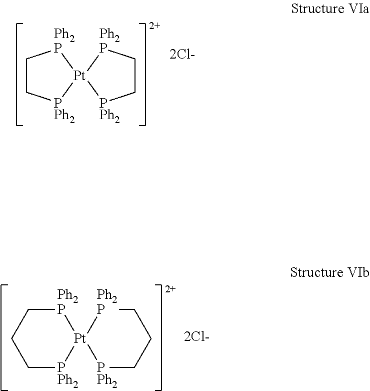

### EXAMPLES

### 1. Materials

All reactions were carried out under in the dark. All the reagents and solvents were used as received without further purification

### 2. General Measurements

NMR spectra were collected on a Bruker Ascend AVANCE Ill 600 MHz spectrometer or a Bruker AVANCE Ill 400 MHz spectrometer. Chemical shifts are reported in parts per million compared with residual solvent peaks. ESI-MS was performed on an Agilent API-2000 Triple-Q MS/MS spectrometer. High-resolution ESI-MS data were obtained on Thermo Scientific LTQ Qrbitrap XL mass spectrometer. Elemental analysis was performed using a Vario Micro elemental analyzer.

3. Synthesis and characterizations
3.1 Synthesis of t-[Pt(R₁COO)(R₂COO)(PPh₃)₂]

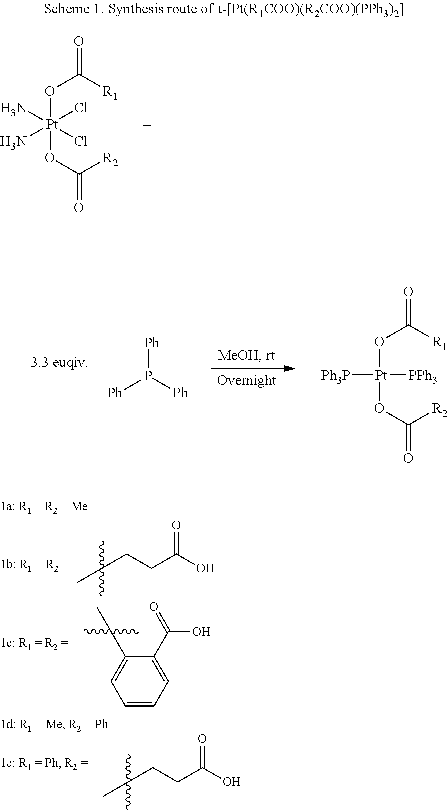

Scheme 1. Synthesis route of t-[Pt(R₁COO)(R₂COO)(PPh₃)₂]

Triphenylphosphine (PPh₃, 3.3 equiv., 0.56 mmol, 147 mg), together with carbozolyl (IV) complexes {0.17 mmol, which is 71 mg of c,c,t-[Pt(NH₃)₂Cl₂(acetato)₂], 91 mg of c,c,t-[Pt(NH₃)₂Cl₂(succinato)₂], 107 mg of c,c,t-[Pt(NH₃)₂Cl₂(phthalato)₂], 82 mg of c,c,t-[Pt(NH₃)₂Cl₂(acetate)(benzoato)], or 92 mg of c,c,t-[Pt(NH₃)₂Cl₂(acetate)(benzoato)]} was dissolved in MeOH (5 mL). The reaction mixture was then stirred at room temperature overnight, after which the solvent was removed by rotary evaporation, and the crude product was collected and purified by column chromatography (silica gel, 10:1 DCM:MeOH). The product was obtained as an off white solid.

t-[Pt(acetato)₂(PPh₃)₂] (1a). Yield: 67%, 95 mg (0.11 mmol). Anal Calcd for: C₄₀H₃₆O₄P₂Pt (837.76): C, 57.35; H, 4.33; N, 0.00. Found: C, 57.43; H, 4.30; N, 0.04. ¹H NMR (600 MHz, Chloroform-d) δ 7.76 (q, J=5.8 Hz, 12H), 7.42 (t, J=7.2 Hz, 6H), 7.38 (t, J=7.3 Hz, 12H), 0.88 (s, 6H). ¹³C NMR (151 MHz, Chloroform-d) δ 176.0, 134.8 (t, J_{P-C}=6.4 Hz), 130.4, 129.2 (t, J_{P-C}=27.7 Hz), 128.1 (t, J=5.3 Hz), 21.1. ³¹P NMR (243 MHz, Chloroform-d) δ 14.2 (s+d, J_{Pt-P}=3069.1 Hz). ¹⁹⁵Pt NMR (129 MHz, Chloroform-d) δ-2896.3 (t, J_{P-P}t=3080.1 Hz). ESI-MS (positive ion mode): δ37.9 m/z [M+H]⁺; calcd for C₄₀H₃₇O₄P₂Pt m/z 838.2 [M+H]⁺.

t-[Pt(succinato)₂(PPh₃)₂] (1b). Yield: 71%, 115 mg (0.12 mmol). Anal Calcd for: C₄₄H4₀O₈P₂Pt (953.83): C, 55.41; H, 4.23; N, 0.00. Found: C, 55.24; H, 4.15; N, 0.05. ¹H NMR (600 MHz, Chloroform-d) δ 12.89 (s, 2H), 7.66 (q, J=6.2 Hz, 12H), 7.50 (t, J=7.4 Hz, 6H), 7.43 (t, J=7.5 Hz, 12H), 1.53-1.51 (m, 4H), 1.49-1.44 (m, 4H). ¹³C NMR (151 MHz, Chloroform-d) δ 181.1, 173.6, 134.5 (t, J_{P-C}=6.4 Hz), 131.2, 128.6 (t, J_{P-C}=5.4 Hz), 127.9 (t, J_{P·C}=28.1 Hz), 31.4, 29.7. ³¹P NMR (243 MHz, Chloroform-d) δ 14.5 (s+d, J_{Pt-P}=2928.2 Hz). ¹⁹⁵Pt NMR (129 MHz, Chloroform-d) δ-2911.5 (t, J_{P-Pt}=3025.1 Hz). ESI-MS (positive ion mode): 953.9 m/z [M+H]⁺; calcd for C₄₄H₄₁O₈P₂Pt m/z 954.2 [M+H]⁺.

t-[Pt(phthalato)₂(PPh₃)₂] (1c). Yield: 66%, 118 mg (0.11 mmol). Anal Calcd for: C₅₂H4₀O₈P₂Pt (1049.92): C, 59.49; H, 3.84; N, 0.00. Found: C, 59.10; H, 3.90; N, 0.07. ¹H NMR (600 MHz, Chloroform-d) δ 16.02 (s, 2H), 8.08 (d, J=7.6 Hz, 2H), 7.73 (q, J=5.9 Hz, 12H), 7.35 (t, J=7.4 Hz, 6H), 7.33-7.31 (m, 2H), 7.29 (t, J=7.3 Hz, 12H), 7.11-7.07 (m, 4H). ¹³C NMR (151 MHz, Chloroform-d) δ 174.7, 166.8, 134.4 (t, J_{P-C}=6.5 Hz), 133.3, 132.4, 131.7, 131.3, 131.2, 130.5, 130.4, 128.7 (t, J_{P-C}=5.4 Hz), 127.2 (t, J_{P-C}=28.4 Hz). ³¹P NMR (243 MHz, Chloroform-d) δ 15.5 (s+d, J_{Pt-P}=2896.6 Hz). ¹⁹⁵Pt NMR (129 MHz, Chloroform-d) δ-2924.3 (t, J_{P·Pt}=2903.1 Hz). ESI-MS (positive ion mode): 1049.9 m/z [M+H]⁺; calcd for C₅₂H₄₁O₈P₂Pt m/z 1050.2 [M+H]⁺.

t-[Pt(acetato)(benzoato)(PPh₃)₂] (1d). Yield: 74%, 113 mg (0.13 mmol). Anal Calcd for: C₄₅H₃₈O₄P₂Pt (899.83): C, 60.07; H, 4.26; N, 0.00. Found: C, 59.89; H, 4.32; N, 0.06. H NMR (600 MHz, Chloroform-d) δ 7.77 (q, J=5.7 Hz, 12H), 7.36-7.29 (m, 18H), 7.11 (t, J=7.3 Hz, 1H), 7.06 (d, J=7.0 Hz, 2H), 6.94 (t, J=7.7 Hz, 2H), 0.88 (s, 3H). ¹³C NMR (151 MHz, Chloroform-d) δ 176.0, 171.0, 134.8 (t, J_{P-C}=6.5 Hz), 130.3, 129.5, 129.2, 129.0, 128.8, 128.1 (t, J_{P-C}=5.3 Hz), 126.4, 21.0. ³¹P NMR (243 MHz, Chloroform-d) δ 14.8 (s+d, J_{Pt-P}=3110.4 Hz). ¹⁹⁵Pt NMR (129 MHz, Chloroform-d) δ-2909.7 (t, J_{P·Pt}=3114.1 Hz). ESI-MS (positive ion mode): 899.9 m/z [M+H]⁺; calcd for C₄₅H3₉O₄P₂Pt m/z 900.2 [M+H]⁺.

t-[Pt(succinato)(benzoato)(PPh₃)₂] (1e). Yield: 69%, 112 mg (0.12 mmol). Anal Calcd for: C₄₇H4₀O₆P₂Pt (957.86): C, 58.94; H, 4.21; N, 0.00. Found: C, 59.32; H, 4.27; N, 0.04. ¹H NMR (600 MHz, Chloroform-d) δ 13.36 (s, 1H), 7.73 (q, J=5.8 Hz, 12H), 7.38 (t, J=7.3 Hz, 6H), 7.33 (t, J=7.3 Hz, 12H), 7.13 (t, J=7.3 Hz, 1H), 7.09 (d, J=7.0 Hz, 2H), 6.96 (t, J=7.7 Hz, 2H), 1.48 (s, 4H). ¹³C NMR (151 MHz, Chloroform-d) δ 181.2, 173.8, 171.2, 134.6, 130.8, 129.8, 128.9, 128.5, 128.4, 128.1, 31.6, 29.7. ³¹P NMR (243 MHz, Chloroform-d) δ 14.8 (s+d, J_{Pt-P}=2986.5 Hz). ¹⁹⁵Pt NMR (129 MHz, Chloroform-d) δ-2914.5 (t, J_{P-Pt}=3014.1 Hz). ESI-MS (positive ion mode): 958.0 m/z [M+H]⁺; calcd for C₄₇H4₁06P₂Pt m/z 958.2 [M+H]⁺.

3.2 Synthesis of t-[Pt(acetato)₂(PR₃)₂]

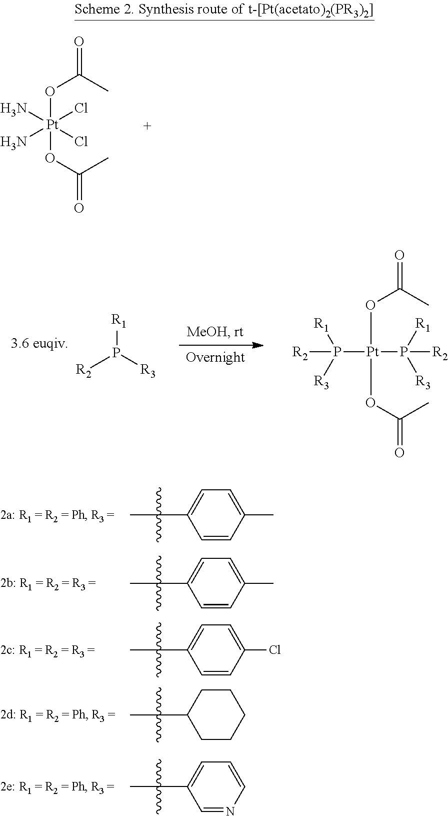

c,c,t-[Pt(NH₃)₂Cl₂(acetato)₂] (71 mg, 0.17 mmol) was suspended in methanol (3 mL), to which 3.6 equiv. of phosphines [0.61 mmol, diphenyl(p-tolyl)phosphine (169 mg), tri(p-tolyl)phosphine (186 mg), tris(4-chlorophenyl)phosphine (224 mg), cyclohexyldiphenylphosphine (164 mg) or diphenyl-2-pyridylphosphine (161 mg)] were added. The mixture was stirred overnight at room temperature. The desired product was isolated and purified by aluminum oxide column chromatography, using dichloromethane/methanol (10:1) as an eluent. After evaporation, the final product was washed with diethyl ether (30 mL) twice and collected as a white solid by centrifugation.

t-[Pt(acetato)₂(C₉H1₇P)₂] (2a). Yield: 63% (91 mg, 0.105 mmol). HRMS (ESI) m/z calculated for C₄₂H₄₁P₂O₄Pt⁺ (M+H)⁺866.21223, found 866.21216. ¹H NMR (600 MHz, Chloroform-d) δ 7.73 (q, J=5.8 Hz, 8H), 7.69-7.64 (m, 4H), 7.39 (m, 12H), 7.20 (d, J=7.7 Hz, 4H), 2.36 (s, 6H), 0.89 (s, 6H). ¹³C NMR (151 MHz, Chloroform-d) δ 175.9, 140.7, 134.9 (t, J=6.6 Hz), 134.7 (t, J=6.4 Hz), 130.2, 129.5 (t, J=27.7 Hz), 128.9 (t, J=5.5 Hz), 128.0 (t, J=5.3 Hz), 125.7 (t, J=28.5 Hz), 21.5, 21.2. ³¹P NMR (243 MHz, Chloroform-d) δ 13.7 (s+d, J=3187.8 Hz). ¹⁹⁵Pt NMR (129 MHz, Chloroform-d) δ-2898.1 (t, J=3077.94 Hz).

t-[Pt(acetato)₂(C₂₁H₂₁P)₂] (2b). Yield: 77% (85 mg, 0.092 mmol). HRMS (ESI) m/z calculated for C₄₆H4₉O₄P₂Pt⁺ (M+H)⁺922.27483, found 922.27423. ¹H NMR (600 MHz, Chloroform-d) δ 7.62 (d, J=6.4 Hz, 12H), 7.17 (d, J=7.4 Hz, 12H), 2.34 (s, 18H), 0.91 (s, 6H). ¹³C NMR (151 MHz, Chloroform-d) δ 175.8, 140.3, 134.7 (t, J=6.5 Hz), 128.8 (t, J=5.5 Hz), 126.2 (t, J=28.6 Hz), 21.4, 21.3. ³¹P NMR (243 MHz, Chloroform-d) δ 12.7 (s+d, J=3061.8 Hz). ¹⁹⁵Pt NMR (129 MHz, Chloroform-d) δ-2898.5 (t, J=3045.7 Hz).

t-[Pt(acetato)₂(C₁₈H1₂Cl₃P)₂] (2c). Yield: 64% (112 mg, 0.107 mmol). HRMS (ESI) m/z calculated for C₄₀H₃₁O₄P₂Cl₆Pt⁺ (M+H)⁺1041.94710, found 1041.94666. ¹H NMR (600 MHz, Chloroform-d) δ 7.62 (m, 12H), 7.40 (d, J=8.4 Hz, 12H), 0.97 (s, 6H). ¹³C NMR (151 MHz, Chloroform-d) δ 176.2, 137.8, 135.8 (t, J=7.0 Hz), 128.8 (t, J=5.6 Hz), 126.5 (t, J=28.5 Hz), 21.2. ³¹P NMR (243 MHz, Chloroform-d) δ 12.7 (s+d, J=3134.7 Hz). ¹⁹⁵Pt NMR (129 MHz, Chloroform-d) δ-2914.0 (t, J=3134.7 Hz).

t-[Pt(acetato)₂(C₁₈H₂₁P)₂] (2d). Yield: 51% (105 mg, 0.123 mmol). HRMS (ESI) m/z calculated for C₄₀H₄₉O₄P₂Pt⁺ (M+H)⁺850.27483, found 850.27423. ¹H NMR (600 MHz, Chloroform-d) δ 7.74-7.67 (m, 8H), 7.40 (m, 12H), 2.51 (t, J=12.2 Hz, 2H), 2.11 (d, J=12.4 Hz, 4H), 1.69 (s, 4H), 1.60 (d, J=12.9 Hz, 2H), 1.39 (s, 6H), 1.28 (q, J=13.1 Hz, 4H), 0.96 (m, 6H). ¹³C NMR (151 MHz, Chloroform-d) δ 176.9, 134.1 (t, J=5.7 Hz), 129.9, 127.8 (t, J=4.8 Hz), 34.1, 28.4, 27.2, 26.1, 22.0. ³¹P NMR (243 MHz, Chloroform-d) δ 21.0 (s+d, J=2940.3 Hz). ¹⁹⁵Pt NMR (129 MHz, Chloroform-d) δ-2844.1 (t, J=2967.0 Hz).

t-[Pt(acetato)₂(C₁₇H1₄NP)₂] (2e). Yield: 28% (39 mg, 0.047 mmol). HRMS (ESI) m/z calculated for C₃₈H3₅O₄N₂P₂Pt⁺ (M+H)⁺840.17143, found 840.17102. ¹H NMR (600 MHz, Chloroform-d) δ 8.74-8.71 (m, 2H), 8.51 (d, J=4.5 Hz, 2H), 7.87 (q, J=5.7 Hz, 8H), 7.78 (t, J=8.7 Hz, 2H), 7.42 (t, J=7.2 Hz, 4H), 7.38 (t, J=7.2 Hz, 8H), 7.30 (d, J=7.5 Hz, 2H), 0.89 (s, 6H). ¹³C NMR (151 MHz, Chloroform-d) δ 176.4, 149.9 (t, J=7.2 Hz), 135.8 (t, J=5.1 Hz), 135.0 (t, J=6.3 Hz), 132.9 (t, J=14.7 Hz), 130.5, 128.7 (t, J=28.3 Hz), 128.0 (t, J=5.4 Hz), 124.2, 20.9. ³¹P NMR (162 MHz, Chloroform-d) δ 15.6 (s+d, J=3094.2 Hz). ¹⁹⁵Pt NMR (129 MHz, Chloroform-d) δ-2925.8 (t, J=3121.8 Hz).

3.3 Synthesis of {Pt[Ph₂P(CH₂)₂PPh₂]2}Cl₂ and {Pt[Ph₂P(CH₂)₃PPh₂]2}Cl₂

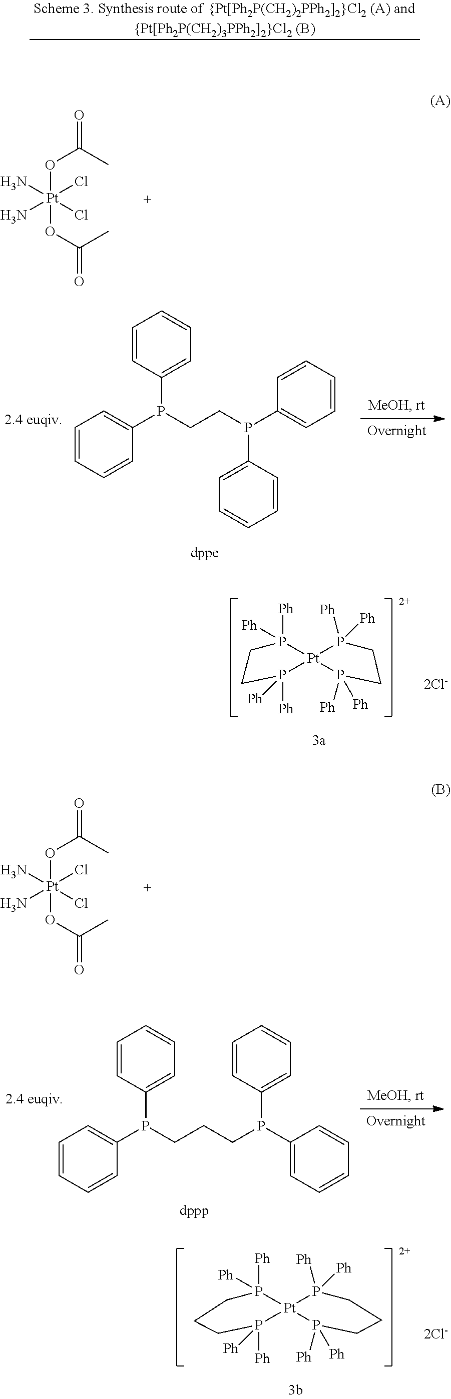

c,c,t-[Pt(NH₃)₂Cl₂(acetato)₂] (71 mg, 0.17 mmol) was suspended in methanol (3 mL), to which 2.4 equiv. of phosphines [0.41 mmol, 1,2-bis(diphenylphosphino)ethane (dppe, 162 mg) or 1,3-bis(diphenylphosphino)propane (dppp, 168 mg)] were added. The mixture was stirred overnight at room temperature. The desire product was formed as white precipitate and collected by centrifugation. After washing with diethyl ether (30 mL) for twice, the final product was collected as white solid.

[Pt(C₂₆H2₄P₂)₂]C1₂ (3a) Yield: 34%. (60 mg, 0.057 mmol) HRMS (ESI) m/z calculated for C₅₂H4₈CIP₄Pt⁺ (M-Cl)⁺1027.20491, found 1027.20496; m/z calculated for C₅₂H4₈P₄Pt²⁺ (M-2C1)²+495.61793, found 495.61902. ¹H NMR (600 MHz, Chloroform-d) δ 7.73-7.67 (m, 16H), 7.33 (t, J=7.3 Hz, 16H), 7.30 (d, J=7.2 Hz, 8H), 3.36 (t, J=7.9 Hz, 8H). ¹³C NMR (151 MHz, Chloroform-d) δ 134.8, 132.0, 129.1, 126.1, 31.9. ³¹P NMR (243 MHz, Chloroform-d) δ 47.2 (s+d, J=2357.1 Hz).

[Pt(C₅₄H₅₂P₂)]Cl₂(3b). Yield: 73%. (133 mg, 0.122 mmol)¹H NMR (600 MHz, D₂O) δ 7.40 (t, J=6.5 Hz, 8H), 7.28 (d, J=6.5 Hz, 32H), 2.61 (t, J=6.5 Hz, 8H), 2.03-1.91 (m, 4H). ¹³C NMR (151 MHz, D₂O) δ 133.27, 132.52, 129.38, 126.01-125.41 (m), 23.98-23.46 (m), 16.96. ³¹P NMR (243 MHz, D₂O) 6-7.0 (s+d, J=2189.2 Hz).

### 4. Cytotoxicity Test

### 4.1 Cell Lines and Cell Culture Conditions

Human ovarian A2780 and cisplatin-resistant A2780cisR cells were maintained in Roswell Park Memory Institution (RPMI) 1640 medium supported with 10% FBS, 2 mM L-glutamine, and 100 unit/mL penicillin/streptomycin. Human lung carcinoma A549 cells, cisplatin-resistant A549cisR cells, and human breast MCF-7 cells were cultured in Dulbecco's Modified Eagle Medium (DMEM) with 10% FBS and 100 units penicillin/streptomycin.

### 4.2 Cytotoxicity Test

The viability of cancer cells exposed to the compounds was evaluated by means of MTT assay. Cells were seeded in 96-well plates at a density of 3,000 cells per well and incubated until the cell confluency reached 50%. Then, the medium was removed and replaced with fresh medium containing different concentrations of complexes with 1% DMF. For complex 3a and 3b with A2780, A2780CisR, A549 and A549CisR cells, the medium used for replacement contains no DMF. After 72 h, the medium was changed to serum-free medium containing 1 mg/mL MTT. After 2 h additional incubation, the medium was removed, and DMSO (200 μL) was delivered to each well to dissolve the formed purple formazan. The absorbance at 570 nm and 730 nm of each well was measured using a microplate reader (BioTek PowerWave XS).

4.3 Cytotoxicity result

TABLE 1
Cytotoxicity of complexes 1a to 1e, 2a to 2e, 3a, 3b and cisplatin.

| | 72 h IC₅₀ (μM) | | | | |
|---|---|---|---|---|---|
| Complexes | A2780 | A2780cisR | A549 | A549cisR | MCF-7 |
| 1a | 4.3 ± 0.6 | 3.3 ± 0.8 | 3.3 ± 0.6 | 5 ± 1 | 10 ± 1 |
| 1b | 15 ± 1 | 13 ± 1 | 5.3 ± 0.6 | 8 ± 5 | — |
| 1c | 18 ± 3 | 10 ± 2 | 7 ± 1 | 7 ± 2 | — |
| 1d | 4.9 ± 0.6 | 3.1 ± 0.2 | 5 ± 3 | 5 ± 1 | — |
| 1e | 8 ± 4 | 7.2 ± 0.2 | 5.0 ± 0.8 | 5 ± 2 | — |
| 2a | 8 ± 1 | 7 ± 2 | 28 ± 3 | — | 7 ± 1 |
| 2b | 4 ± 1 | 4 ± 1 | 6.1 ± 0.3 | — | 4 ± 0.3 |
| 2c | 4 ± 1 | 4 ± 1 | 24 ± 7 | — | 18 ± 2 |
| 2d | >2.4 | >2.4 | >2.7 | — | >2.4 |
| 2e | >9.4 | >9.4 | >11.1 | — | >9.4 |
| 3a | 12 ± 3 | 5 ± 1 | 3.6 ± 0.2 | 1.3 ± 0.1 | 7 ± 1 |
| 3b | 0.23 ± 0.09 | 2.6 ± 0.6 | 0.48 ± 0.02 | 0.07 ± 0.01 | 0.2 ± 0.01 |
| cisplatin | 2.1 ± 0.6 | 23 ± 6 | 2.0 ± 0.1 | 12 ± 1 | 18 ± 3 |

1. A platinum complex having a structure of Structure (II): 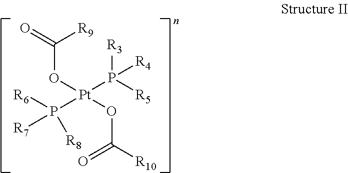
wherein
R₃, R₄, R₅, R₆, R₇ and R₈ are independently selected from the group consisting of a hydrogen atom, a substituted or unsubstituted linear or branched chain C1 to C5 alkyl group, a cycloalkyl group, a substituted or unsubstituted aryl group, and a heteroaryl group, optionally R₃ is identical to R₆, R₄ is identical to R₇, and R₅ is identical to R₈;
R₉ and R₁₀ are independently selected from the group consisting of a hydrogen atom, a substituted or unsubstituted linear or branched chain C1 to C5 alkyl group, a substituted or unsubstituted aryl group, and a carboxyl group; and
n is an electrical charge of the complex and is 0, a positive integer or a negative integer;
wherein the substituted linear or branched chain C1 to C5 alkyl group or the substituted aryl group is substituted with a halo group, —NH₂, an amine substituted with one or two C1-C5 alkyl, a linear or branched chain C1 to C5 alkyl group, a C1 to C5 alkoxy group, a C1 to C5 acyl group or a C1 to C5 carboxyl group.

2. The platinum complex as claimed in claim 1, wherein R and R₁₀ are independently selected from the group consisting of a methyl group, 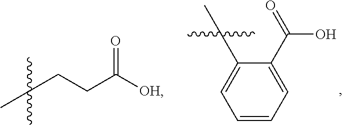 [SMILES: *CCC(=O)O ; *c1ccccc1C(=O)O]
and a phenyl group.

3. The platinum complex as claimed in claim 2, wherein
R₃, R₄, R₆ and R₇ are identical and are independently selected from the group consisting of
a phenyl group, 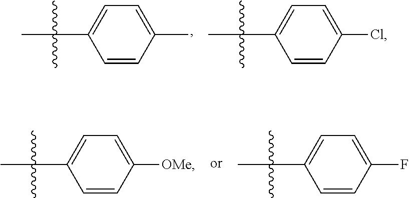
R₆ and R₈ are identical and are independently selected from the group consisting of
an ethyl group,

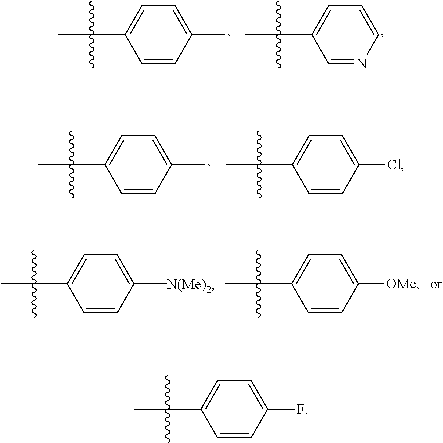

4. The platinum complex as claimed in claim 1, wherein:
R₃, R₄, R₆, R₆, R₇ and R₈ are independently phenyl, and R₉ and R₁₀ are independently methyl; or
R₃, R₄, R₆, R₆, R₇ and R₈ are independently phenyl, and R₉ and
R₁₀ are independently 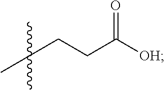 [SMILES: *CCC(=O)O]
R₃, R₄, R₅, R₆, R₇ and R₈ are independently phenyl, and R₉ and R₁₀ are independently 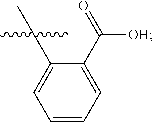 [SMILES: *c1ccccc1C(=O)O]
or
R₃, R₄, R₅, R₆, R₇ and R₈ are independently phenyl, R₉ is methyl, and R₁₀ is phenyl;
or
R₃, R₄, R₅, R₆, R₇ and R₈ are independently phenyl, R is phenyl, and R₁₀ is

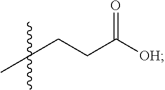 [SMILES: *CCC(=O)O]

5. The platinum complex as claimed in claim 1, wherein the complex has the structure of Structure III: 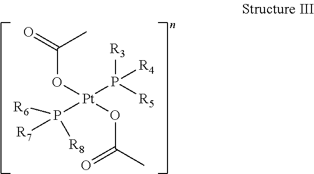
wherein,
n is an electrical charge of the complex and is 0, a positive integer or a negative integer;
R₃, R₄, R₆ and R₇ are independently phenyl, and R₅ and R₈ are independently 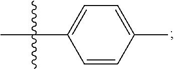 [SMILES: *c1ccc(C)cc1 ; ";"]
or
R₃, R₄, R₅, R₆, R₇ and R₈ are independently 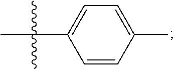 [SMILES: *c1ccc(C)cc1 ; ";"]
or
R₃, R₄, R₅, R₆, R₇ and R₈ are independently 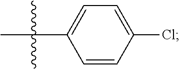 [SMILES: *c1ccc(Cl)cc1]
or
R₃, R₄, R₆ and R₇ are independently phenyl, and R₅ and R₈ are independently 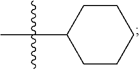 [SMILES: *C1CCCCC1 ; ";"]
or
R₃, R₄, R₆ and R₇ are independently phenyl, and R₅ and R₈ are independently

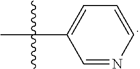 [SMILES: *c1cccnc1 ; "."]

6. The platinum complex as claimed in claim 5, wherein
R₃, R₄, R₆ and R₇ are independently phenyl, and R₅ and R₈ are independently 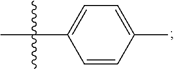 [SMILES: *c1ccc(C)cc1 ; ";"]
or
R₃, R₄, R₆, R₆, R₇ and R₈ are independently 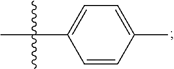 [SMILES: *c1ccc(C)cc1 ; ";"]
or
R₃, R₄, R₅, R₆, R₇ and R₈ are independently 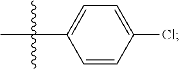 [SMILES: *c1ccc(Cl)cc1]
or
R₃, R₄, R₆ and R₇ are independently phenyl, and R₅ and R₈ are independently 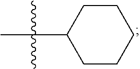 [SMILES: *C1CCCCC1 ; ";"]
or
R₃, R₄, R₆ and R₇ are independently phenyl, and R₅ and R₈ are independently

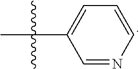 [SMILES: *c1cccnc1 ; "."]

7. The platinum complex as claimed in claim 1, wherein the platinum complex has the structure of Structure IV: 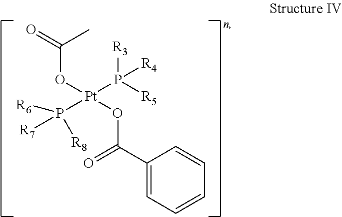
wherein, n is an electrical charge of the complex and is 0, a positive integer or a negative integer.

8. The platinum complex as claimed in claim 7, wherein PR₆R₇R₈ and PR₃R₄R₅ are represented by phosphine ligands selected from the group consisting of 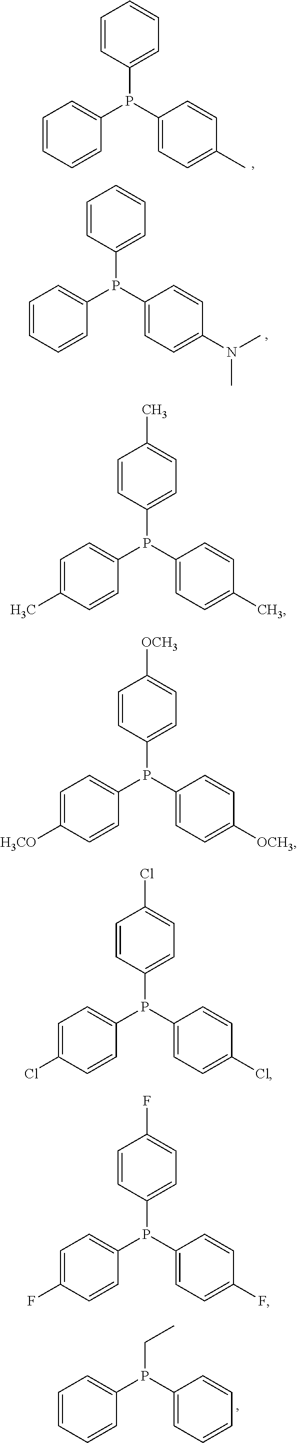 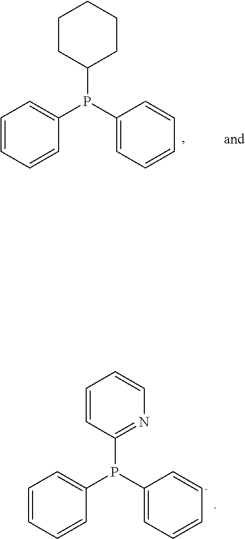 [SMILES: c1ccc(P(c2ccccc2)C2CCCCC2)cc1 ; c1ccc(P(c2ccccc2)c2ccccn2)cc1]
